(19) United States
(12) Patent Application Publication
(10) Pub. No.: US 2003/0020985 A1
(43) Pub. Date: Jan. 30, 2003

(54) Receiver for high-speed optical signals

(76) Inventors: Michael J. LaGasse, Lexington, MA (US); Simon Verghese, Arlington, MA (US); Sean M. Duffy, West Newton, MA (US); Lawrence J. Kushner, Andover, MA (US); Barry Romkey, Burlington, MA (US)

Correspondence Address: RAUSCHENBACH PATENT LAW GROUP, POST OFFICE BOX 387, BEDFORD, MA, 01730, US

(21) Appl. No.: 10/077,000

(22) Filed: Feb. 15, 2002

Related U.S. Application Data
(60) Provisional application No. 60/269,454, filed on Feb. 16, 2001.

(51) Int. Cl. H04J 14/08; H04B 10/06

(52) U.S. Cl. 359/135; 359/189

(57) ABSTRACT

A demultiplexer is described that includes an optical splitter that receives an optical data signal having a plurality of data channels and that generates a plurality of identical optical data signals. An electrical clock recovery circuit receives the optical data signal and generates an electrical clock signal that is synchronized to the optical data signal and that has a frequency that is an integer multiple of a bit rate of one of the plurality of data channels. One of a plurality of phase shifters receives the electrical clock signal and generates a phase-shifted electrical clock signal in response to a control signal applied to one of the plurality of phase shifters. A respective one of a plurality of sampling circuits receives one of the identical optical data signals and the phase-shifted electrical clock signal and generates an electrical signal representing a data channel of the optical data signal.

### RELATED APPLICATIONS

This patent application claims priority to U.S. provisional patent application Serial No. 60/269,454 that was filed on Feb. 16, 2001, the entire disclosure of which is incorporated herein by reference.

### FIELD OF THE INVENTION

The present invention relates to receivers and demultiplexers for high-speed single and multi-wavelength optical communication systems. In particular, the present invention relates to methods and apparatus for receiving high-speed signals and demultiplexing high-speed signals into multiple lower speed signals.

### BACKGROUND OF THE INVENTION

Modem optical fiber communication systems transmit data signals at very high data rates (i.e. high speeds). These systems require a receiver that detects high-speed optical signals and processes the optical signals into electronic waveforms. Some receivers demultiplex the received high-speed optical signals into multiple lower speed electronic data signals. These systems require high-speed demultiplexers.

Because of the limited speed and performance of currently available electrical demultiplexers, a combination of optical and electrical demultiplexing techniques are typically employed to demultiplex data signals with data rates exceeding 40 Gb/s. While the first generation of 40 Gb/s electrical demultiplexers are currently available, they are generally difficult to incorporate into commercial systems because they have relatively low sensitivity, limited speed, require excessive power, are relatively expensive, and generally cannot scale to higher data rates. In addition, there are no commercially available electrical demultiplexers that can demultiplex polarization multiplexed data signals.

One type of high-speed demultiplexer uses electro-optical devices. For example, one type of electro-optic demultiplexer uses Mach-Zehnder interferometric modulators to reduce the bit rate by one half by rejecting alternate bits in the incoming signal. Another type of high-speed demultiplexer uses all-optical components. For example, one type of all-optical demultiplexer uses a nonlinear optical-loop mirror that includes a fiber loop whose ends are connected to two input ports of a fiber coupler. Another type of all-optical demultiplexer uses a non-linear medium configured to perform four-wave mixing. These prior art electro-optic and all-optical demultiplexers are relatively complex, difficult to implement, and expensive.

### SUMMARY OF THE INVENTION

The present invention relates to methods and apparatus for demultiplexing high-speed Optical Time-Division Multiplexing (OTDM) communication systems and Optical Polarization-Division Multiplexing (PDM) communication systems. A relatively simple and inexpensive high-speed receiver can be constructed from an electrical demultiplexer that uses high-speed sampling circuits according to the present invention.

Accordingly, the present invention features a demultiplexer that demultiplexes an optical data signal. The demultiplexer can demultiplex numerous types of optical data signals. For example, the demultiplexer can demultiplex bit interleaved optical time-division multiplexed optical signals and packet interleaved optical time-division multiplexed optical signals. In addition, the demultiplexer can demultiplex polarization multiplexed optical signals and bit interleaved optical time-division multiplexed polarization multiplexed optical signals.

The demultiplexer includes an optical splitter. The optical splitter has an input that receives an optical data signal having a plurality of data channels. The optical splitter also has a plurality of outputs. The optical splitter generates a plurality of substantially identical optical data signals at the plurality of outputs.

The demultiplexer also includes an electrical clock recovery circuit that includes an input that receives the optical data signal and an output. The electrical clock recovery circuit generates an electrical clock signal at the output. The electrical clock signal is substantially synchronized to the optical data signal and has a frequency that is an integer multiple of a bit rate of one of the plurality of data channels.

In one embodiment, the electrical clock recovery circuit includes a photodetector that receives the optical data signal and generates an electrical data signal that is related to the optical data signal. A narrow-band amplifier amplifies the electrical data signal generated by the photodetector. A phase-locked loop synchronizes a frequency and a phase of a local oscillator onto a frequency and a phase of the electrical data signal generated by the photodetector.

The demultiplexer also includes a plurality of phase shifters. Each of the plurality of phase shifters includes a clock input that receives the electrical clock signal and a control input that receives a control signal. A respective one of the plurality of phase shifters generates a phase-shifted electrical clock signal in response to a control signal applied to the control input of the respective one of the plurality of phase shifters.

The demultiplexer also includes a plurality of sampling circuits. Each of the plurality of sampling circuits includes a data input and a clock input. The data input receives one of the plurality of substantially identical optical data signals. The clock input receives one of the plurality of phase-shifted electrical clock signals. Each of the plurality of sampling circuits generates an electrical signal that represents one of the plurality of data channels of the optical data signal at an output. In one embodiment, the demultiplexer includes at least one demultiplexer circuit that has an input that is electrically coupled to the output of at least one of the plurality of sampling circuits.

In one embodiment, at least one of the plurality of sampling circuits comprises a photodetector that receives the plurality of substantially identical optical data signals and generates an electrical data signal that is related to the optical data signal having the plurality of data channels. In another embodiment, at least one of the plurality of sampling circuits comprises an electro-absorption modulator.

In one embodiment, the control input of a respective one of the plurality of phase shifters is electrically coupled to the output of a respective one of the plurality of sampling circuits. In this embodiment, the respective one of the plurality of phase shifters generates a phase-shifted electrical clock signal in response to the electrical signal representing one of the plurality of data channels of the optical data signal.

In one embodiment, the demultiplexer includes a processor that has an output that is electrically coupled to the control input of one of the plurality of phase shifters. The processor generates a control signal that causes the phase shifter to generate the desired phase-shifted electrical clock signal in response to the electrical signal representing one of the plurality of data channels of the optical data signal.

The present invention also features a method of demultiplexing. The method includes generating a plurality of substantially identical optical data signals from an optical data signal having a plurality of data channels. The optical data signal can be any one of numerous types of optical data signals. For example, the optical data signal can be a bit interleaved optical time-division multiplexed optical signal or a packet interleaved optical time-division multiplexed optical signal. In addition, the optical data signal can be a polarization multiplexed optical signal or a bit interleaved optical time-division multiplexed polarization multiplexed optical signal.

An electrical clock signal is generated from the optical data signal having the plurality of data channels. The electrical clock signal is substantially synchronized to the optical data signal and has a frequency that is an integer multiple of a bit rate of one of the plurality of data channels of the optical data signal.

A plurality of phase-shifted electrical clock signals is generated in response to at least one control signal where a respective one of the plurality of phase-shifted electrical clock signals is synchronized to a respective one of the plurality of data channels. A portion of each of the plurality of substantially identical optical data signals is sampled thereby generating a plurality of sampled optical data signals. In one embodiment, sampling the portion of each of the plurality of substantially identical optical data signals reduces the intersymbol interference in at least one of the a plurality of sampled optical data signals.

A respective one of the plurality of sampled optical data signals is synchronized to a respective one of the plurality of data channels. In one embodiment, at least one control signal is generated from one of the plurality of sampled optical data signals. In one embodiment, each of the plurality of sampled optical data signals is further demultiplexed to generate a plurality of demultiplexed optical data signals.

The present invention also features a demultiplexer for polarization multiplexed optical signals that includes a polarization beamsplitter. The demultiplexer can demultiplex numerous types of optical data signals. For example, the demultiplexer can demultiplex bit interleaved optical time-division multiplexed polarization multiplexed optical signals and packet interleaved optical time-division multiplexed polarization multiplexed optical signals.

The polarization beamsplitter includes an input that receives a polarization multiplexed optical signal having a plurality of data channels. The polarization beamsplitter generates at least two optical data signals having different polarization states at a plurality of outputs.

The demultiplexer also includes an electrical clock recovery circuit that has an input that receives the polarization multiplexed optical signal. The electrical clock recovery circuit generates an electrical clock signal at an output. The electrical clock signal is substantially synchronized to the polarization multiplexed optical signal and has a frequency that is an integer multiple of a bit rate of one of the plurality of data channels.

The demultiplexer also includes a plurality of phase shifters. Each of the plurality of phase shifters includes a clock input that receives the electrical clock signal and a control input. A respective one of the plurality of phase shifters generates a phase-shifted electrical clock signal in response to a signal that is applied to the control input of the respective one of the phase shifters.

The demultiplexer also includes a plurality of sampling circuits. Each of the plurality of sampling circuits includes a data input that receives one of the at least two optical data signals and a clock input that receives one of the plurality of phase-shifted electrical clock signals. Each of the plurality of sampling circuits generates an electrical signal representing one of the plurality of data channels of the polarization multiplexed optical signal at an output.

The control input of the respective one of the plurality of phase shifters is electrically coupled to the output of a respective one of the plurality of sampling circuits. The respective one of the plurality of phase shifters generates a phase-shifted electrical clock signal in response to the electrical signal representing one of the plurality of data channels of the polarization multiplexed optical signal. In one embodiment, at least one of the plurality of sampling circuits comprises a photodetector that receives the one of the at least two optical data signals and generates an electrical data signal that is related to the polarization multiplexed optical signal having the plurality of data channels.

In one embodiment, the demultiplexer includes at least one demultiplexer circuit having an input that is electrically coupled to the output of at least one of the plurality of sampling circuits.

The present invention also features a method of demultiplexing polarization multiplexed optical signals. The method includes generating at least two optical data signals having different polarization states from a polarization multiplexed optical signal having a plurality of data channels. The optical data signal can be any one of numerous types of optical data signals. For example, the optical data signals can be a bit interleaved optical time-division multiplexed polarization multiplexed optical signal or can be a packet interleaved optical time-division multiplexed polarization multiplexed optical signals.

An electrical clock signal is generated from the polarization multiplexed optical signal. The electrical clock signal is substantially synchronized to the polarization multiplexed optical signal and has a frequency that is an integer multiple of a bit rate of one of the plurality of data channels. A plurality of phase-shifted electrical clock signals is generated in response to at least one control signal. A respective one of the plurality of phase-shifted electrical clock signals is synchronized to a respective one of the plurality of data channels.

A portion of each of the at least two optical data signals is sampled thereby generating at least two sampled optical data signals. A respective one of the at least two sampled optical data signals is synchronized to a respective one of the plurality of data channels. In one embodiment, at least one control signal is generated by the sampling one of the at least two optical data signals.

In one embodiment, sampling the portion of each of the at least two optical data signals reduces the intersymbol interference in at least one of the at least two sampled optical data signals. Also, in one embodiment, each of the at least two sampled optical data signals generates a plurality of demultiplexed optical data signals.

### BRIEF DESCRIPTION OF THE DRAWINGS

This invention is described with particularity in the detailed description. The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 illustrates a schematic diagram of a prior art bit interleaved OTDM transmitter that uses optical multiplexing to multiplex N data channels.

FIG. 2 illustrates a schematic block diagram of an electrical demultiplexer for an OTDM optical communication system that uses high-speed sampling circuits according to the present invention.

FIG. 3 illustrates a clock recovery circuit that can be used with the electrical demultiplexer of the present invention.

FIG. 4 illustrates a schematic block diagram of a polarization division multiplexed optical fiber communication system.

FIG. 5 illustrates a schematic block diagram of a polarization division multiplexer that generates a polarization multiplexed optical signal according to the present invention.

FIG. 6 illustrates a schematic block diagram of an electrical demultiplexer for a polarization division multiplexed optical fiber communication system that uses high-speed sampling circuits according to the present invention.

FIG. 7 illustrates a schematic block diagram of an electrical demultiplexer for a polarization division multiplexed optical fiber communication system that uses high-speed sampling circuits and demultiplexing circuits according to the present invention.

FIG. 8 shows a simulation of an optical pulse being sampled according to the present invention.

### DETAILED DESCRIPTION

Optical Time-Division Multiplexing (OTDM) communication systems can transmit data in a single optical data channel at ultra-high bit rates. Functionally OTDM is identical to electronic TDM. Bits associated with different data channels are interleaved in the time domain to form a bit interleaved optical bit stream.

OTDM transmitters and receivers use high-speed optical multiplexing and demultipexing techniques. In operation, OTDM transmitters multiplex several lower-speed optical bit streams modulated at bit rate R to form a bit interleaved optical bit stream modulated at bit rate RN, where N is the number of multiplexed optical data channels. OTDM receivers receive the bit interleaved optical bit stream at bit rate NR and extract the lower-speed optical bit streams modulated at bit rate R.

OTDM transmitters are described in U.S. patent application Ser. No. 09/566,303, entitled “Bit Interleaved Optical Multiplexing,” which was filed on May 8, 2000, and which is assigned to the current assignee. The entire disclosure of U.S. patent application Ser. No. 09/566,303 is incorporated herein by reference.

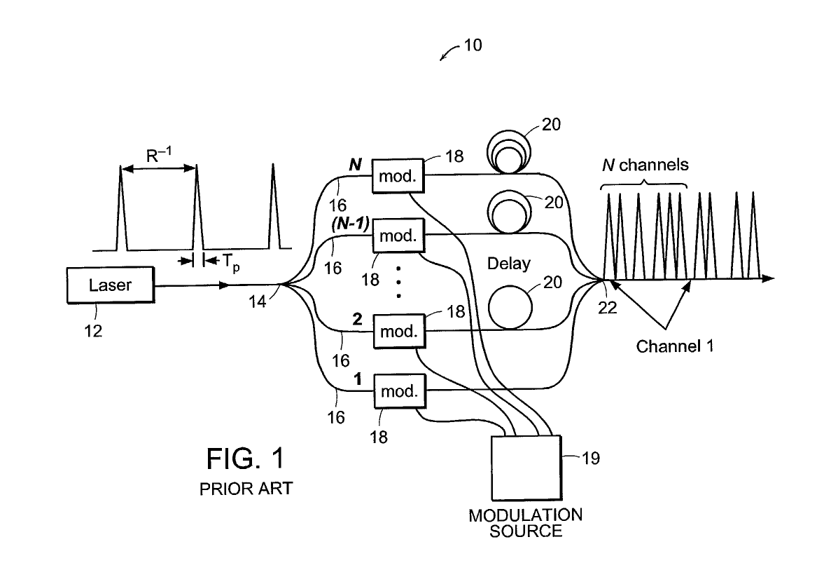

FIG. 1 illustrates a schematic diagram of a prior art bit interleaved OTDM transmitter 10 that uses optical multiplexing to multiplex N data channels. A laser 12 generates an optical clock signal that comprises a periodic pulse train having a repetition rate equal to a single-channel bit rate R and at a pulse width Tp, where Tp is less than (NR)-1 to ensure that each pulse can be positioned in its allocated time slot.

An optical splitter 14, such as a 1×N fused fiber coupler, splits the laser output equally into N arms 16 and directs each of the arms 16 to an electro-optic modulator 18. For example, the electro-optic modulator 18 can be a lithium niobate or semiconductor waveguide modulator.

The electro-optic modulator 18 in each arm 16 is modulated by a synchronized electrical modulation signal that is generated by an electrical modulation source 19. In operation, each of the modulators 18 blocks the pulse for every “0” bit and passes the pulse for every “1” bit, thereby creating N independent bit streams propagating at the bit rate R.

Multiplexing the N independent bit streams is achieved by an optical delay technique. An optical delay 20 is inserted into each arm 16 after the modulator 18. Each of the optical delays has a predetermined precision optical time delay that is different from each of the other optical time delays. One arm may not have an optical delay other than an optical delay associated with an optical waveguide that couples the modulator to the output of the OTDM transmitter 10, as illustrated in FIG. 1. The optical delay 20 delays the modulated bit stream in the n^{th} arm by an amount equal to (n−1)/(RN). An optical combiner 22 recombines the output of the N arms 16 to form a bit interleaved optical bit stream. The bit interleaved optical bit stream is a multiplexed bit stream where each bit is positioned in a time slot.

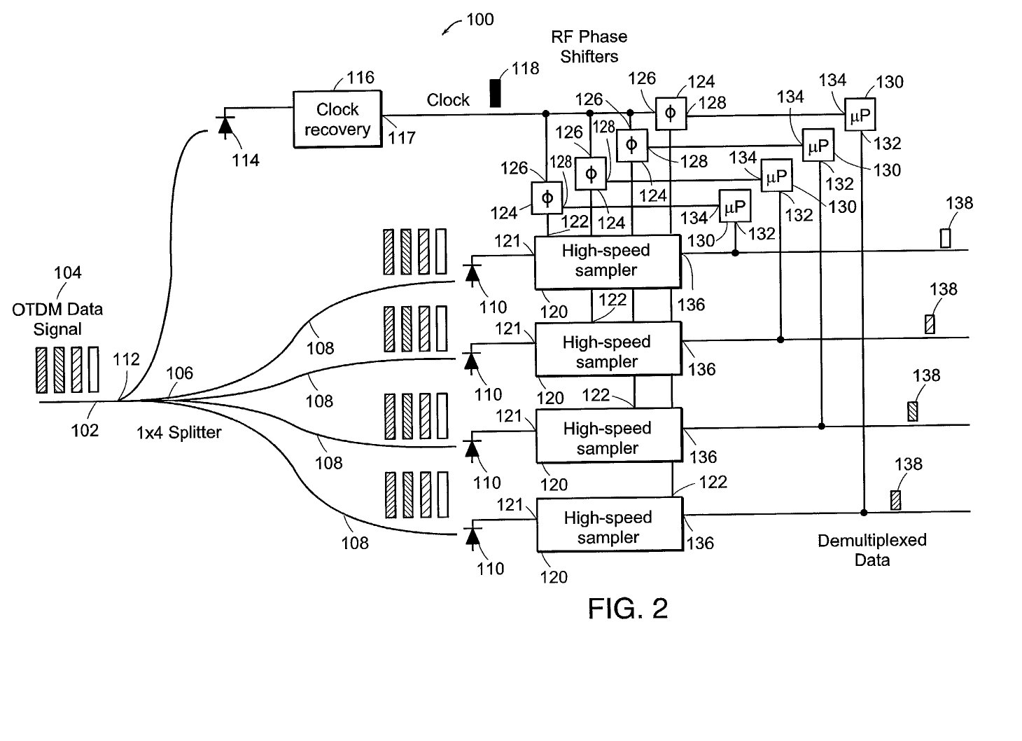

FIG. 2 illustrates a schematic block diagram of an electrical demultiplexer 100 for an OTDM optical communication system that uses high-speed sampling circuits according to the present invention. The electrical demultiplexer 100 includes an optical input 102 that receives a high-speed OTDM data signal 104 that is generated by an OTDM transmitter, such as the OTDM transmitter 10 that was described in connection with FIG. 1, and that has been transmitted across an optical fiber communication link (not shown).

An optical splitter 106 is optically coupled to the optical input 102. The optical splitter 106 splits the received high-speed optical data signal 104 into N data channels or arms 108. The optical splitter 106 can be any type of optical splitter. For example, in one embodiment, the optical splitter 106 is a 1×N fused fiber coupler that includes an optical input and N output optical fibers. In another embodiment, the optical splitter 106 is a bulk optic splitter.

The electrical demultiplexer 100 includes a plurality of high-speed photodetectors 110. A high-speed photodetector 110 is optically coupled to each of the N arms 108. The high-speed photodetectors 110 can be high-speed photodiodes. In one embodiment, each of the high-speed photodetectors 110 is positioned proximate to and in optical communication with the end face of each of the N optical fibers comprising the N arms 108. The photodetectors 110 convert the received high-speed OTDM data signals into high-speed electrical TDM data signals.

The electrical demultiplexer 100 also includes a clock recovery device. An optical coupler 112 is used to couple a portion of the received high-speed OTDM data signal 104 to a clock recovery photodetector 114. The optical coupler 112 can be coupled to the received data signal at the optical input 102 of the electrical demultiplexer 100. In another embodiment (not shown), the optical coupler 112 can be coupled to one of the arms 108. In this embodiment, the optical coupler 112 is coupled a portion of the received high-speed OTDM data signal 104 that is split by the optical splitter 106.

In one embodiment, the clock recovery photodetector 114 is a high-speed photodiode. The photodetector 114 converts the portion of the received high-speed optical data signal 104 into a high-speed electrical data signal that is used to recover the clock signal from the OTDM data signal 104.

An electrical clock recovery circuit 116 is electrically coupled to an output of the clock recovery photodetector 114. The clock recovery circuit 116 generates a recovered clock signal 118 at an output 117 that has a frequency that is synchronized to the OTDM data signal 104. In one embodiment, the recovered clock signal 118 is down-converted to a frequency that is equal to or that is harmonically related to the single data channel bit rate.

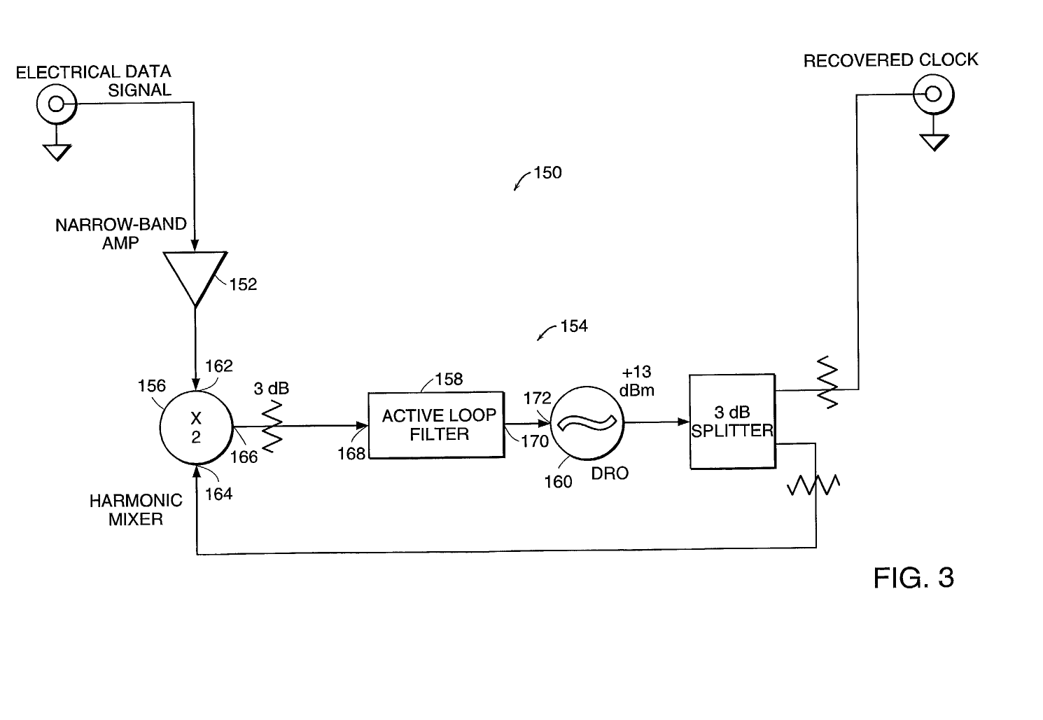

Numerous types of clock recovery circuits can be used with the electrical demultiplexer 100. One particular clock recovery circuit that can be used with the electrical demultiplexer 100 is discussed herein in connection with FIG. 3. The clock recovery circuit 116 synchronizes or “locks” the frequency and the phase of a local oscillator onto the frequency and the phase of the electrical TDM signal and generates an error signal that is proportional to the phase error.

The electrical demultiplexer 100 includes a plurality of high-speed sampling circuits 120 that are configured in parallel to substantially simultaneously sample a portion of the electrical data signals. Numerous types of electronic sampling circuits can be used with the electrical demultiplexer of the present invention. Electronic sampling circuits have been developed for high-speed sampling oscilloscopes. Such sampling circuits are commercially available and are relatively inexpensive. For example, one type of high-speed sampling circuit uses four Schottky diodes (not shown) connected in a balanced configuration to achieve an 8-10 ps (picoseconds) aperture (sampling) time.

Other types of high-speed sampling circuits use nonlinear transmission lines. Yet other types of sampling circuits use electro-absorption modulators (EAM). These types of sampling circuits can be used to achieve even shorter sampling aperture (sampling) times. In an embodiment of a sampling circuit including an EAM (not shown), the photodetector 110 is not used since an EAM can sample each of the received high-speed OTDM data signals directly. In this embodiment, a photodetector (not shown) is coupled to an output of the EAM. The photodector (not shown) converts the sampled optical data into a demultiplexed electrical TDM data signal.

Each of the high-speed sampling circuits 120 includes an electrical input 121 that receives the electrical TDM data signal that is generated by one of the high-speed photodetectors 110. In addition, each of the high-speed sampling circuits 120 includes a clock input 122 that receives the recovered clock signal 118.

Each of the electronic high-speed sampling circuits 120 generates a portion of the electrical TDM data signal. In operation, the phase of the recovered clock signal 118 that is applied to the clock input 122 determines the time at which the sampling circuits 120 sample the electrical TDM data signal. Thus, the phase of the recovered clock signal 118 determines the portion of the electrical TDM data signal that is sampled by the high-speed sampling circuits 120.

The electrical demultiplexer 100 also includes a plurality of RF phase shifters 124 that are used to control the phase of the recovered clock signal 118 that is applied to the clock input 122 of the plurality of high-speed sampling circuits 120. Each of the plurality of RF phase shifters 124 includes an electrical input 126 that is electrically coupled to the output 117 of the clock recovery circuit 116 and that receives the recovered clock signal 118. In addition, each of the plurality of RF phase shifters 124 includes a control input 128 that receives a control signal.

The electrical demultiplexer 100 also includes a plurality of processors 130 that generate control signals for the plurality of RF phase shifters 124. Each of the plurality of processors 130 includes an input 132 and an output 134. The output 134 of a respective one of the plurality of processors 130 is electrically connected to the control input 128 of a respective one of the plurality of RF phase shifters 124. In one embodiment, the input 132 of a respective one of the plurality of processors 130 is electrically coupled to an output 136 of a respective one of the high-speed sampling circuits 120.

In operation, the control input 128 of a respective one of the plurality of RF phase shifters 124 receives a control signal that is generated at the output 134 of a respective one of the plurality of processors 130. A respective one of the RF phase shifters 124 changes the phase of the recovered clock signal 118 in response to a respective one of the control signals. Each of the plurality of phase shifters 124 changes the phase of the recovered clock signal 118 to a desired phase that causes a respective one of the high-speed sampling circuits 120 to sample the desired portion of the electrical TDM data signal.

The output of each of the high-speed sampling circuits 120 is a single data channel demultiplexed electrical TDM data signal 138. The data rate of each of the demultiplexed electrical TDM data signals 138 is 1/N^{th} of the data rate of the recovered clock signal 118, where N is the number of data channels or the number of arms 108. The demultiplexed electrical TDM data signals 138 can be processed so that their signal levels are appropriate for decision circuits and other receiver electronics.

For example, the electrical demultiplexer 100 can be used to demultiplex a bit interleaved optical bit stream modulated at 40 GB/sec bit into four bit interleaved optical bit streams modulated at 10 GB/sec. A 40 GHz clock signal is recovered from the 40 GB/sec data waveform. The 40 GHz clock signal is down converted by harmonic mixing to a 10 GHz clock signal. Each of the high-speed sampling circuits 120 selects a single 10 GB/sec data waveform from the 40 GB/sec waveform. The phase of the 10 GHz clock signal received by each of the high-speed sampling circuits 120 is adjusted by one of the phase shifters 124 to select the desired 10 GB/sec data waveform and, thus to select the desired data channel.

The present invention also relates to receivers and demultiplexers for high-speed single and multi-wavelength polarization multiplexed optical communication systems. Optical Polarization-Division Multiplexing (PDM) is a type of optical multiplexing that multiplexes polarized optical pulse trains into a single bit interleaved optical pulse train having at least two polarization states.

FIG. 3 illustrates a clock recovery circuit 150 that can be used with the electrical demultiplexer of the present invention. The clock recovery circuit 150 includes a narrow-band amplifier 152 that amplifies an electrical data signal. In addition, the clock recovery circuit 150 includes a Phase-Locked Loop (PLL) 154. The PLL 154 synchronizes or locks the frequency and phase of a local oscillator onto the frequency and phase of the electrical TDM signal. In one embodiment, the PLL 154 is a linear PLL. The PLL includes a Phase Detector (PD) 156 or phase comparator, a Loop Filter (LF) 158, and a Voltage Controlled Oscillator (VCO) or Dielectric Resonant Oscillator (DRO) 160.

The PLL 154 includes a phase detector 156 that has a first input 162 that receives the filtered electrical data signal and a second input 164 that receives a signal from the VCO 160. The phase detector 156 compares the phase of the electrical data signal with the phase of the signal generated by the VCO or DRO 160 and generates at an output 166 a signal that includes a DC component and a superimposed AC component. The DC component is proportional to the phase error between the electrical data signal and the signal generated by the VCO or DRO 160.

In one embodiment, the phase detector 156 is a harmonic mixer. A harmonic mixer is a three-port device that includes a nonlinear element. The harmonic mixer mixes the electrical data signal with a local oscillator signal and generates an error signal that has a DC component and a superimposed AC component. The DC component of the error signal has a magnitude that is proportional to the phase error.

The PLL 154 includes a loop filter 158 that has an input 168 that is electrically connected to the output 166 of the phase detector 156. The loop filter 158 filters the error signal generated by the phase detector 156 and passes the filtered signal to an output 170. In one embodiment, the loop filter 158 is a low pass lead-lag loop filter that includes a phase leading and phase lagging filter network. The phase leading network controls the dampening of the PLL 154. The loop filter 158 may be an active filter that has gain greater than one. In this embodiment, the loop filter 158 substantially cancels the AC component of the signal generated by the phase detector 156.

The VCO 160 has a control input 172 that is electrically connected to the output 170 of the loop filter 158. The VCO 160 generates a local oscillator signal that has a frequency, which is determined by the magnitude of the error signal. In one embodiment, the VCO 160 is a Dielectric Resonator Oscillator (DRO). In other embodiments, the clock recovery circuit 150 includes a Current Controlled Oscillator (CCO).

In operation, when the frequency and phase of the VCO or DRO is synchronized or locked onto the frequency and phase of the electrical TDM signal, the phase error between the output signal of the VCO or DRO and the reference signal is substantially zero or a constant. If a phase error accumulates, the PLL 154 changes the frequency and/or phase of the oscillator so that the phase error is reduced to a minimum, thereby synchronizing or locking the phase of the output signal to the phase of the reference signal.

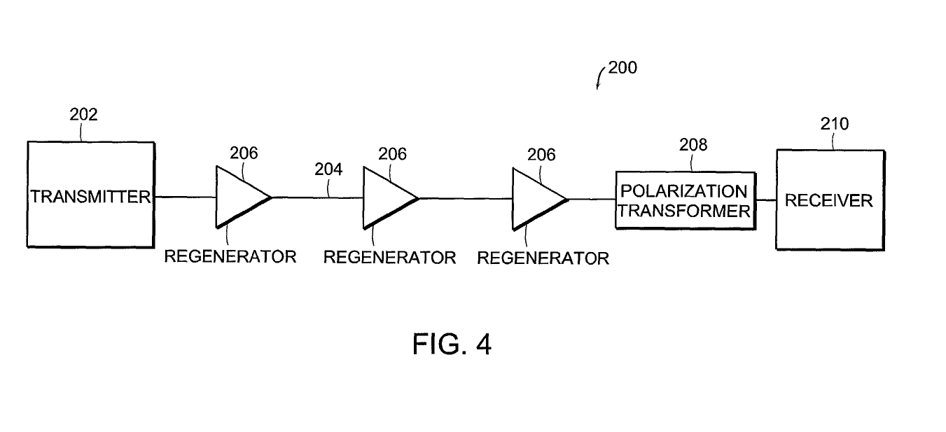

FIG. 4 illustrates a schematic block diagram of a polarization division multiplexed (PDM) optical fiber communication system 200. The communication system 200 includes an optical polarization multiplexed transmitter 202 that generates a polarization multiplexed bit interleaved optical pulse train. Polarization multiplexed optical signals include multiple data channels that have different polarization states. That is, the pulse train comprises bits that have different polarization states associated with them.

In one embodiment, the polarization state of the polarization multiplexed bit interleaved optical pulse train alternates so that every other bit in the polarization multiplexed bit interleaved optical pulse train has the same polarization state. Numerous other types of polarization multiplexing can be used with the demultiplexer and receiver of the present invention. For example, orthogonal linear polarization multiplexing and orthogonal circular polarization multiplexing can be used. Also, in other embodiments, the different polarization states overlap in time.

Standard single-mode optical fibers can support PDM because two orthogonal states of polarization can exist in the fundamental mode of single mode optical fiber. The relative orthogonal nature of the polarization states is preserved in standard single mode optical fibers even though the polarization states of the optical pulse trains change in a random manner as the pulse trains propagate. This assumes that polarization effects, such as polarization mode dispersion (PMD) and polarization-dependent loss (PDL) are not significant enough to destroy the orthogonal nature of the polarization states in the polarized pulse trains.

The polarization multiplexed bit interleaved optical pulse train is transmitted though an optical fiber communication link 204. The communication link 204 can include numerous repeaters or regenerators 206 that are positioned along the link 204. Repeaters or regenerators 206 are periodically placed along the link 204 to compensate for loss introduced by the optical fiber communication link 204.

The repeaters or regenerators 206 can be electrical regenerators that include receiver-transmitter pairs that detect the incoming optical signal, recover the electrical pulse train, and then convert the electrical pulse train back into an optical pulse train having desired signal levels. The repeaters or regenerators 206 can also be all-optical amplifiers.

The PDM optical fiber communication system 200 includes a polarization controller or polarization transformer 208. Polarization transformers are described in U.S. patent application Ser. No. 09/769,671 entitled “Automatic Polarization Controller for Polarization Multiplexed Optical Signals,” which is assigned to the present assignee. The entire disclosure of U.S. patent application Ser. No. 09/769,671 is incorporated herein by reference.

Polarization transformers are typically needed in PDM optical fiber communication systems because the absolute polarization states of the two orthogonally polarized pulse trains is typically unknown since polarization is not preserved as the optical pulse trains propagate in a communication link. Polarization transformers are used to align the absolute polarization state of the two orthogonally polarized optical pulse trains so the data in the two pulse trains can be processed.

The polarization transformer 208 receives the polarization multiplexed bit interleaved optical pulse train that was transmitted though the optical fiber communication link 204. The polarization transformer 208 then transforms the arbitrary polarization state of the bit interleaved optical pulse trains into a known stable state of polarization so that it can be processed by polarization sensitive components.

An optical receiver 210 receives the multiplexed bit interleaved optical pulse train having the known state of polarization and processes the pulse train into useful information. An optical receiver according to the present invention includes a polarization division demultiplexer. In one embodiment of the invention, the polarization division demultiplexer includes a plurality of detectors and a plurality of high-speed sampling circuits as described herein.

PDM communication systems have numerous advantages over non-PDM communication systems. One advantage of PDM communication systems is that they have greater spectral efficiency compared with non-PDM systems. This is because data propagates in two orthogonally polarized pulse trains at a single wavelength. Thus, polarization division multiplexing effectively doubles the data capacity. Another advantage of PDM communication systems is that they have higher dispersion tolerance as compared with non-PDM systems. For example, the dispersion tolerance of PDM communication systems can be four times greater than comparable non-PDM systems.

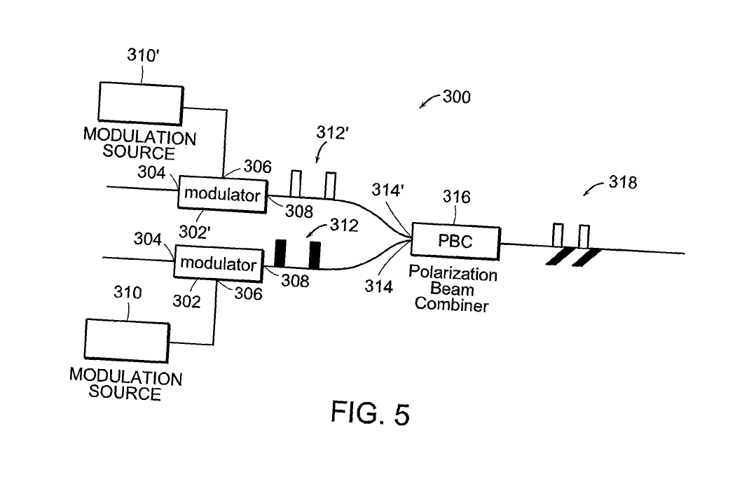

FIG. 5 illustrates a schematic block diagram of a polarization division multiplexer 300 that generates a polarization multiplexed optical signal according to the present invention. Polarization-division multiplexing is described in U.S. patent application Ser. No. 09/782,569, entitled “Polarization Division Multiplexer,” which is assigned to the present assignee. The entire disclosure of U.S. patent application Ser. No. 09/782,569 is incorporated herein by reference.

The multiplexer 300 includes a first 302 and a second data modulator 302′. Any type of optical modulator can be used, such as an electro-optical, an electro-absorption, liquid crystal, solid-state, or polymer modulator. Each of the modulators 302, 302′ includes an optical input 304, an electrical modulation signal input 306, and an optical output 308. The modulators 302, 302′ can modulate amplitude or phase or both amplitude and phase of optical signals applied to the optical inputs 304.

The multiplexer 300 also includes a first 310 and a second electrical modulation source 310′. The outputs of the first 310 and the second electrical modulation sources 310′ are electrically connected to the electrical modulation signal input 306 of the first 302 and the second modulators 302′, respectively. The electrical modulation sources 310, 310′ can be separate and independent modulation sources or can be one modulation source having two outputs. In one embodiment, the first 310 and the second electrical modulation sources 310′ are unsynchronized.

Each of the first 310 and the second electrical modulation sources 310′ generates a data signal. In one embodiment, the data signals generated by each of the electrical modulation sources 310, 310′ have a relative phase that aligns each bit of the optical pulse trains into the desired bit order as described herein. By desired bit order, we mean the desired position of one bit relative to another bit in a pulse train.

In one embodiment, an optical clock signal is applied to the optical input 304 of each of the modulators 302, 302′. The optical clock signal is modulated by the data signals generated by the first and the second electrical modulation sources 310, 310′ and applied to the electrical modulation signal inputs 306. The first 302 and the second modulators 302′ generate a first 312 and a second modulated optical pulse train 312′ comprising the modulated data. In one embodiment, the modulated optical pulse trains 312, 312′ have the same polarization state.

In another embodiment, the first 302 and the second data modulators 302′ are directly modulated lasers. The data signals generated by the first and the second electrical modulation sources 310, 310′ are applied to the first and the second directly modulated lasers, respectively, to generate the first 312 and the second modulated optical pulse trains 312′.

In another embodiment, the modulators 302, 302′ are pulse carving modulators that include a pulse carving section. A CW optical signal is applied to the optical inputs 304 and the pulse carving section generates an optical clock signal. Pulse carving is known in the art and is described, for example, in U.S. Pat. No. 4,505,587, entitled “Picosecond Optical Sampling.” Using a modulator with a pulse carving section is advantageous because the optical clock signal is derived from the modulation signal and, therefore, the modulation signal is inherently synchronized to the optical clock signal.

The optical output 308 of the first 302 and the second modulator 302′ is optically coupled to a first 314 and a second optical input 314′ of a beam splitter/combiner 316. In one embodiment, the beam splitter/combiner 316 is a polarization beam splitter/combiner 316. Polarization beam combiners are advantageous because they have relatively low loss. Numerous other beam splitter/combiners, such as couplers and polarization maintaining couplers, can be used. In one embodiment, polarization maintaining optical fibers are used to optically couple the outputs 308 of the modulators 302, 302′ to the inputs 314, 314′ of the polarization beam splitter/combiner 316. The polarization beam combiner 316 assembles or combines the modulated optical pulse trains into a single orthogonally polarized bit interleaved pulse train 318. In other embodiments, the polarized bit interleaved pulse train 318 is not orthogonally polarized, but has two different polarization states.

Although the multiplexer of FIG. 5 is described in connection with two modulators, any number of modulators can be used to polarization division multiplex any number of pulse trains. In some embodiments, at least two optical beam combiners are used to combine optical outputs from a plurality of modulators and generate two bit interleaved modulated optical pulse trains that are optically coupled to inputs 314, 314′ of the polarization beam splitter/combiner 316, as described herein.

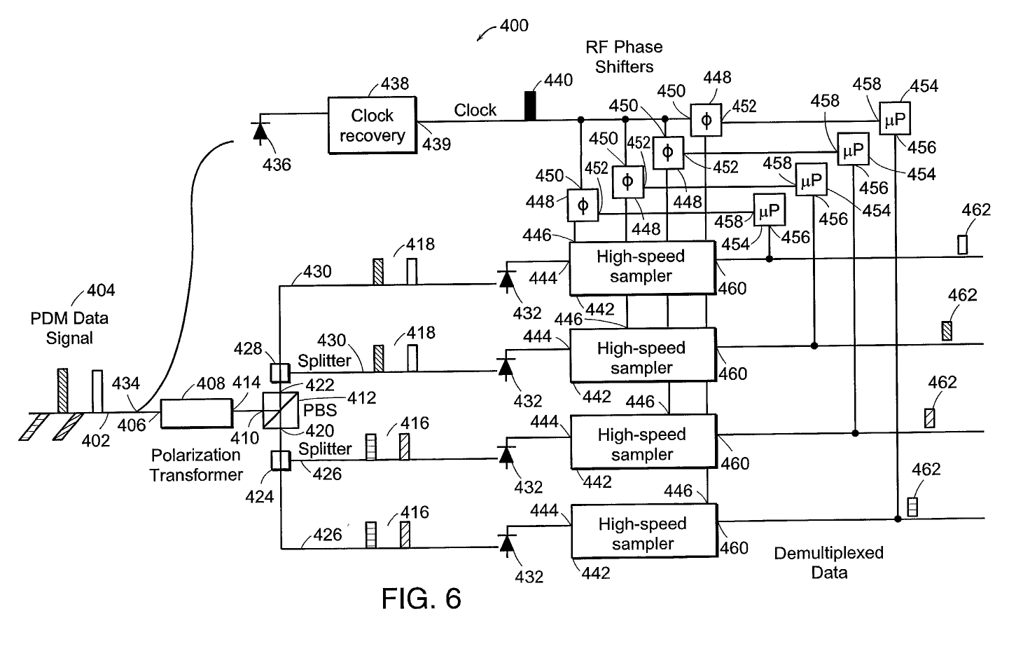

FIG. 6 illustrates a schematic block diagram of an electrical demultiplexer 400 for a polarization division multiplexed optical fiber communication system that uses high-speed sampling circuits according to the present invention. The electrical demultiplexer 400 includes an optical input 402 that receives a high-speed PDM data signal 404 that is generated by a PDM transmitter, such as the PDM multiplexer 400 that was described in connection with FIG. 5, and that has been transmitted across an optical fiber communication link (not shown).

An input 406 of a polarization transformer 408 is optically coupled to the optical input 402. The polarization transformer 408 receives the PDM data signal 404 and transforms an arbitrary polarization state of the PDM data signal 404 into a known stable state of polarization so that it can be processed by polarization sensitive components.

An input 410 of a polarization beam splitter 412 is optically coupled to an output 414 of the polarization transformer 408. The polarization beam splitter 412 receives the transformed polarization multiplexed optical pulse train and passes a first 416 and a second orthogonally polarized optical pulse train 418 at a first 420 and a second output 422, respectively.

A first optical splitter 424 splits the first orthogonally polarized optical pulse train 416 into two arms 426. A second optical splitter 428 splits the second orthogonally polarized optical pulse train 418 into two arms 430. The first 424 and the second optical splitters 428 can be any type of optical splitter. For example, in one embodiment, the first 424 and the second optical splitters 428 are 1×N fused fiber couplers that include an optical input and two output optical fibers. In another embodiment, the first 424 and the second optical splitters 428 are bulk optic splitters.

The electrical demultiplexer 400 also includes a plurality of high-speed photodetectors 432. In one embodiment, the high-speed photodetectors 432 are high-speed photodiodes. A high-speed photodetector 432 is optically coupled to each of the two arms 426 split from the first optical splitter 424. A high-speed photodetector 432 is also optically coupled to each of the two arms 430 split from the second optical splitter 428.

In one embodiment, the high-speed photodetectors 432 are positioned proximate to and in optical communication with the end face of optical fibers comprising the two arms 426 split from the first optical splitter 424 and the two arms 430 split from the second optical splitter 428. The high-speed photodetectors 432 convert the transformed polarization multiplexed optical pulse train into high-speed electrical TDM data signals.

The electrical demultiplexer 400 also includes a clock recovery device. An optical coupler 434 is used to couple a portion of the transformed polarization multiplexed optical pulse train to a clock recovery photodetector 436. In one embodiment, the clock recovery photodetector 436 is a high-speed photodiode. The optical coupler 434 can be coupled to the received data signal at the optical input 402 of the electrical demultiplexer 400. An electrical clock recovery circuit 438 is electrically coupled to an electrical output of the clock recovery photodetector 436. The clock recovery circuit 438 generates a recovered clock signal 440 at an output 439 that has a frequency that is synchronized to the PDM data signal 404. In one embodiment, the clock signal is down-converted to a frequency that is equal to or that is harmonically related to the single data channel bit rate.

In another embodiment (not shown), the optical coupler 434 is coupled to one of the arms 426, 430. In this embodiment, the optical coupler 434 is used to couple a portion of one of the first 416 and the second orthogonally polarized optical pulse trains 418 to the clock recovery photodetector 436.

Numerous types of clock recovery circuits can be used with the electrical demultiplexer 400. In one embodiment, the clock recovery circuit 438 includes a narrow-band amplifier (not shown) and a Phase-Locked Loop (PLL) (not shown) as described in connection with the clock recovery circuit 150 of FIG. 3. The narrow-band amplifier amplifies the electrical data signal. The PLL synchronizes or “locks” the frequency and the phase of a local oscillator onto the frequency and the phase of the electrical TDM signal generating the recovered clock signal 440.

The electrical demultiplexer 400 also includes a plurality of high-speed sampling circuits 442 that are configured in parallel to substantially simultaneously sample a portion of the electrical data signals. Numerous types of electronic sampling circuits can be used with the electrical demultiplexer of the present invention as described in connection with the electrical demultiplexer 100 of FIG. 2.

Each of the high-speed sampling circuits 442 includes an electrical input 444 that receives the electrical TDM data signal that is generated by one of the respective high-speed photodetectors 432. In addition, each of the high-speed sampling circuits 442 includes a clock input 446 that receives the recovered clock signal 440.

Each of the high-speed sampling circuits 442 generates a portion of the high-speed electrical TDM data signals. In operation, the phase of the recovered clock signal 440 that is applied to the clock input 446 determines the time at which the sampling circuits 442 samples the electrical TDM data signal. Thus, the phase of the recovered clock signal 440 determines the portion of the electrical TDM data signal that is sampled by the high-speed sampling circuits 442.

The electrical demultiplexer 400 also includes a plurality of RF phase shifters 448 that are used to control the phase of the recovered clock signal 440 that is applied to the clock input 446 of each of the plurality of high-speed sampling circuits 442. Each of the plurality of RF phase shifters 448 includes an electrical input 450 that is electrically coupled to the output 439 of the clock recovery circuit 438 and that receives the recovered clock signal 440. In addition, each of the plurality of RF phase shifters 448 includes a control input 452.

The electrical demultiplexer 400 also includes a plurality of processors 454 that generate control signals for the plurality of RF phase shifters 448. Each of the plurality of processors 454 includes an input 456 and an output 458. The output 458 of a respective one of the plurality of processors 454 is electrically connected to the control input 452 of a respective one of the plurality of RF phase shifters 448. In one embodiment, the input 456 of a respective one of the plurality of processors 454 is electrically coupled to an output 460 of a respective one of the high-speed sampling circuits 442.

In operation, the control input 452 of a respective one of the plurality of RF phase shifters 448 receives a control signal that is generated at the output 458 of a respective one of the plurality of processors 454. A respective one of the RF phase shifters 448 changes the phase of the recovered clock signal 440 in response to a respective one of the control signals. Each of the plurality of phase shifters 448 changes the phase of the recovered clock signal 440 to a desired phase that causes a respective one of the high-speed sampling circuits 442 to sample the desired portion of the electrical TDM data signal.

The output 460 of each of the high-speed sampling circuits 442 is a single data channel demultiplexed electrical TDM data signal 462. The data rate of each of the demultiplexed electrical TDM data signals 462 is 1/N^{th} of the data rate of the recovered clock signal 440, where N is total the number of data channels or the total number of arms 426, 430, which is four in the embodiment shown in FIG. 6. The demultiplexed electrical TDM data signals 462 may be processed so that their signal levels are appropriate for decision circuits and other receiver electronics.

For example, the electrical demultiplexer 400 can be used to demultiplex a bit interleaved optical bit stream modulated at 40 GB/sec bit into four bit interleaved optical bit streams modulated at 10 GB/sec. A 40 GHz clock signal is recovered from the 40 GB/sec data waveform. The 40 GHz clock signal is down converted by harmonic mixing to a 10 GHz clock signal. Each of the high-speed sampling circuits 442 selects a single 10 GB/sec data waveform from the 40 GB/sec waveform. The phase of the 10 GHz clock signal received by each of the high-speed sampling circuits 442 is adjusted by one of the phase shifters 448 to select the desired 10 GB/sec data waveform and, thus to select the desired data channel.

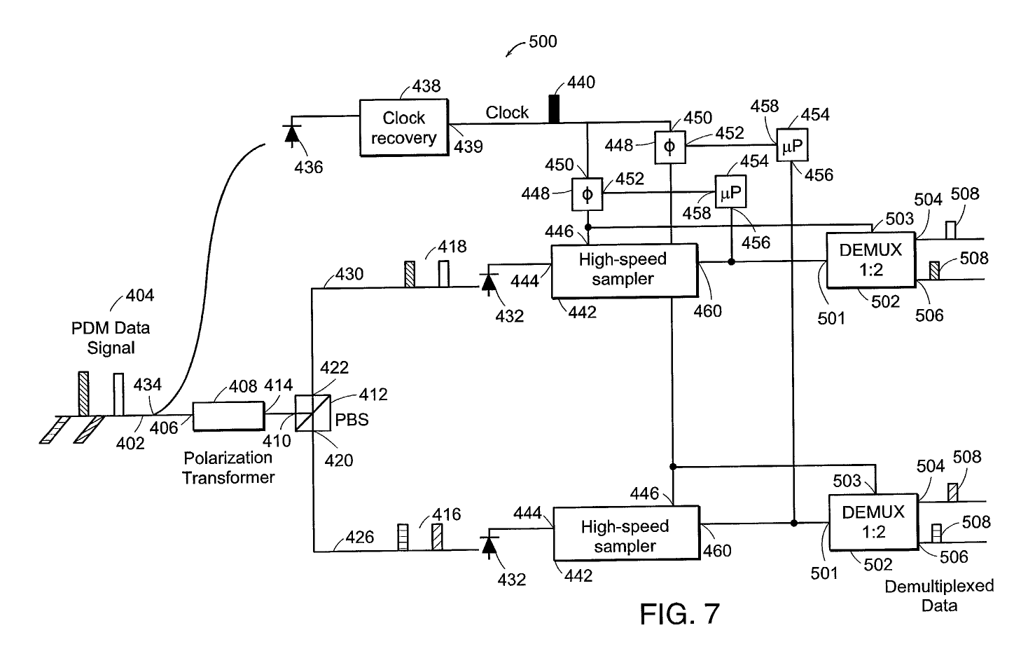

FIG. 7 illustrates a schematic block diagram of an electrical demultiplexer 500 for a polarization division multiplexed optical fiber communication system that uses high-speed sampling circuits and demultiplexing circuits according to the present invention. The electrical demultiplexer 500 is similar to the electrical demultiplexer 400 that was described in connection with FIG. 6.

The demultiplexer 500 includes an optical input 402 that receives a high-speed PDM data signal 404 that is generated by a PDM transmitter, such as the PDM multiplexer 400 that was described in connection with FIG. 6, and that has been transmitted across an optical fiber communication link (not shown). An input 406 of a polarization transformer 408 is optically coupled to the optical input 402. The polarization transformer 408 receives the PDM data signal 404 and transforms an arbitrary polarization state of the PDM data signal 404 into a known stable state of polarization so that it can be processed by polarization sensitive components.

An input 410 of a polarization beam splitter 412 is optically coupled to an output 414 of the polarization transformer 408. The polarization beam splitter 412 receives the transformed polarization multiplexed optical pulse train and passes a first 416 and a second orthogonally polarized optical pulse train 418 at a first 420 and a second output 422, respectively.

The electrical demultiplexer 500 also includes a plurality of high-speed photodetectors 432 that are positioned to receive the first 416 and the second orthogonally polarized optical pulse trains 418. In one embodiment, each of the high-speed photodetectors 432 is positioned proximate to and in optical communication with the end face of a first and a second optical fiber propagating the first 416 and the second orthogonally polarized optical pulse trains 418. The high-speed photodetectors 432 convert the first 416 and the second orthogonally polarized optical pulse trains 418 into high-speed electrical TDM data signals.

The electrical demultiplexer 500 also includes a clock recovery device. An optical coupler 434 is used to couple a portion of the PDM data signal 404 to a clock recovery photodetector 436. In one embodiment, the clock recovery photodetector 436 is a high-speed photodiode. The optical coupler 434 can be coupled to the received PDM optical data signal 404 at the optical input 402 of the electrical demultiplexer 500. The photodetector 436 converts the portion of the PDM data signal 404 into a high-speed electrical data signal that is used to recover the clock signal from the transformed polarization multiplexed optical pulse train.

In another embodiment (not shown), the optical coupler 434 is coupled to one of the arms 426, 430. In this embodiment, the optical coupler 434 is used to couple a portion of one of the first 416 and the second orthogonally polarized optical pulse trains 418 to the clock recovery photodetector 436.

An electrical clock recovery circuit 438 is electrically coupled to an electrical output of the clock recovery photodetector 436. The clock recovery circuit 438 generates a recovered clock signal 440 at an output 439 that has a frequency that is synchronized to the PDM data signal 404. In one embodiment, the clock signal is down-converted to a frequency that is equal to or that is harmonically related to the single data channel bit rate.

Numerous types of clock recovery circuits can be used with the electrical demultiplexer 500. In one embodiment, the clock recovery circuit 438 includes a narrow-band amplifier (not shown) and a Phase-Locked Loop (PLL) (not shown) as described in connection with the clock recovery circuit 150 of FIG. 3.

The electrical demultiplexer 500 also includes a plurality of high-speed sampling circuits 442 that are configured in parallel to substantially simultaneously sample a portion of the electrical data signals. Numerous types of electronic sampling circuits can be used with the electrical demultiplexer of the present invention as described in connection with the electrical demultiplexer 100 of FIG. 2.

Each of the high-speed sampling circuits 442 includes an electrical input 444 that receives the electrical TDM data signal that is generated by one of the respective high-speed photodetectors 432. In addition, each of the high-speed sampling circuits 442 includes a clock input 446 that receives the recovered clock signal 440.

Each of the high-speed sampling circuits 442 generates a portion of the high-speed electrical TDM data signals. In operation, the phase of the recovered clock signal 440 that is applied to the clock input 446 determines the time at which each sampling circuit 442 samples the electrical TDM data signal. Thus, the phase of the recovered clock signal 440 determines the portion of the electrical TDM data signal that is sampled by each of the high-speed sampling circuits 442.

The electrical demultiplexer 500 also includes a plurality of RF phase shifters 448 that are used to control the phase of the recovered clock signal 440 that is applied to the clock input 446 of each of the plurality of high-speed sampling circuits 442. Each of the plurality of RF phase shifters 448 includes an electrical input 450 that is electrically coupled to the output 439 of the clock recovery circuit 438 and that receives the recovered clock signal 440. In addition, each of the plurality of RF phase shifters 448 includes a control input 452.

The electrical demultiplexer 400 also includes a plurality of processors 454 that generate control signals for the plurality of RF phase shifters 448. Each of the plurality of processors 454 includes an input 456 and an output 458. The output 458 of a respective one of the plurality of processors 454 is electrically connected to the control input 452 of a respective one of the plurality of RF phase shifters 448. In one embodiment, the input 456 of a respective one of the plurality of processors 454 is electrically coupled to an output 460 of a respective one of the high-speed sampling circuits 442.

In operation, the control input 452 of a respective one of the plurality of RF phase shifters 448 receives a control signal that is generated at the output 458 of a respective one of the plurality of processors 454. A respective one of the RF phase shifters 448 changes the phase of the recovered clock signal 440 in response to a respective one of the control signals. Each of the plurality of phase shifters 448 changes the phase of the recovered clock signal 440 to a desired phase that causes a respective one of the high-speed sampling circuits 442 to sample the desired portion of the electrical TDM data signal.

The output 460 of each of the high-speed sampling circuits 442 is a multi-channel demultiplexed electrical TDM data signal. The data rate of each of the multi-channel demultiplexed electrical TDM data signals is 1/N^{th} of the data rate of the recovered clock signal 440, where N is total the number of arms, which is two in the embodiment shown in FIG. 7.

The electrical demultiplexer 500 also includes a plurality of demultiplexing circuits 502. An input 501 of a respective one of the plurality of demultiplexing circuits 502 is electrically connected to the output 460 of a respective one of the plurality of high-speed sampling circuits 442. Each of the demultiplexing circuits 502 includes a control input 503 that this coupled to the output of one of the RF phase shifters 448. Each of the demultiplexing circuits 502 receives the recovered clock signal 440 at the control input 503. The plurality of RF phase shifters 448 controls the phase of the recovered clock signal that is applied to the input 503 of each of the plurality of demultiplexing circuits 502.

The demultiplexing circuits 502 further demultiplex the multi-channel demultiplexed electrical TDM data signal into single channel demultiplexed electrical TDM data signals 508 at a first 504 and a second output 506. The single channel demultiplexed electrical TDM data signal 508 may be further processed so that their signal levels are appropriate for decision circuits and other receiver electronics.

For example, the electrical demultiplexer 500 can be used to demultiplex a PDM optical pulse train modulated at 40 GB/sec bit into two multi-channel bit interleaved optical bit streams modulated at 20 GB/sec. A 40 GHz clock signal is recovered from the 40 GB/sec modulated PDM optical pulse train. The 40 GHz clock signal is down converted by harmonic mixing to a 20 GHz clock signal. Each of the high-speed sampling circuits 442 selects a single 20 GB/sec data waveform from the 40 GB/sec waveform. The phase of the 20 GHz clock signal received by each of the high-speed sampling circuits 442 is adjusted by one of the phase shifters 448 to select the desired 20 GB/sec data waveform and, thus to select the desired data channel. The demultiplexer circuits 502 demultiplex the multi-channel 20 GB/sec data waveform into the desired 10 GB/sec data waveforms.

The optical pulses in the OTDM data signal and the PDM optical pulse train broaden due to chromatic dispersion and polarization mode dispersion (PMD) as they propagate through a communication link. For example, optical pulses in the optical data signal can be broadened by about 3 ps over a 1 Mm (megameter) communication link. Such pulse broadening can cause significant intersymbol interference (ISI) in high-speed communication systems. Intersymbol interference occurs when neighboring optical pulses interfere with one another at the sampling time. ISI can occur whenever there is signal level outside the time slots of the pulses.

In one embodiment of the invention, the high-speed sampling circuits 442 of the present invention are also used to reduce ISI in the demultiplexed signal generated by the electrical demultiplexer of the present invention. The sampling time of the high-speed sampling circuits 442 can be adjusted to reduce the signal levels outside of the time slots of the pulses. In this embodiment, the sampling time of the high-speed sampling circuits 442 is chosen to reduce ISI in the portion of the electrical TDM data signal generated by the sampling circuit 442. The sampling time of the high-speed sampling circuits 442 is also chosen so that the portion of the electrical TDM data signal generated by the sampling circuit 442 has enough energy so that decision circuits can accurately detect the signal level.

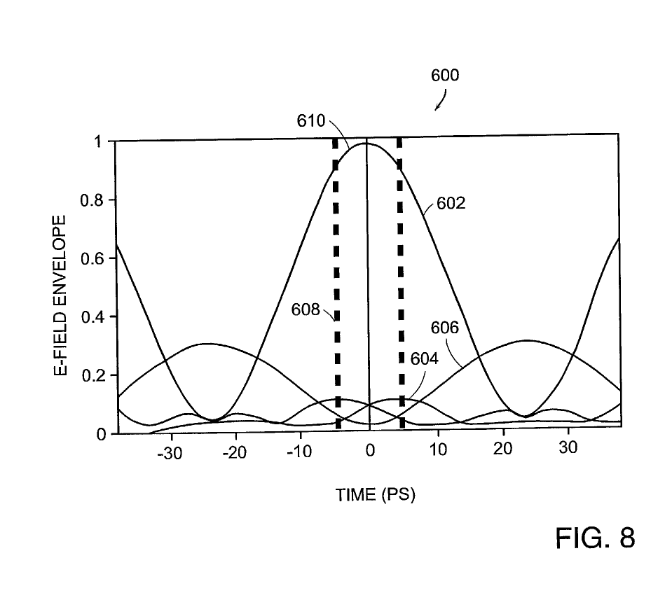

FIG. 8 shows a simulation 600 of an optical pulse 602 being sampled according to the present invention. The simulation 600 illustrates an optical pulse 602 that has been transmitted through a 1 Mm communication link. The optical pulse 602 is broadened by about 3 ps due to chromatic dispersion and PMD. The simulation 600 indicates significant ISI from neighboring optical pulses. The simulation illustrates, for example, co-polarized cross talk 604 and cross-polarized cross-talk 606 that increase ISI.

The simulation 600 illustrates the optical pulse 602 being sampled with a ten (10) ps gating aperture 608. In one embodiment, the optical pulse 602 is sampled with the high-speed sampling circuit of the present invention. In another embodiment, the optical pulse 602 is sampled with an electro-absorption modulator. The sampled portion 610 of the optical pulse 602 has significantly reduced ISI.

Equivalents

While the invention has been particularly shown and described with reference to specific preferred embodiments, it should be understood by those skilled in the art that various changes in form and detail may be made therein without departing from the spirit and scope of the invention as defined herein. For example, the methods and apparatus of the present invention can be used to receive and demultiplex any type of data signal. Also, the methods and apparatus of the present invention can be used to receive and demultiplex both single and multiple wavelength signals.

What is claimed is:

1. A demultiplexer comprising:
a) an optical splitter including an input that receives an optical data signal having a plurality of data channels, the optical splitter generating a plurality of substantially identical optical data signals at a plurality of outputs;
b) an electrical clock recovery circuit including an input that receives the optical data signal, the electrical clock recovery circuit generating an electrical clock signal at an output, the electrical clock signal being substantially synchronized to the optical data signal and having a frequency that is an integer multiple of a bit rate of one of the plurality of data channels;
c) a plurality of phase shifters, each of the plurality of phase shifters including a clock input that receives the electrical clock signal and including a control input, a respective one of the plurality of phase shifters generating a phase-shifted electrical clock signal in response to a signal applied to the control input of the respective one of the plurality of phase shifters; and
d) a plurality of sampling circuits, each of the plurality of sampling circuits including a data input that receives one of the plurality of substantially identical optical data signals, and including a clock input that receives one of the phase-shifted electrical clock signals, each of the plurality of sampling circuits generating an electrical signal representing one of the plurality of data channels of the optical data signal at an output.

2. The demultiplexer of claim 1 wherein the optical data signal comprises a bit interleaved optical time-division multiplexed optical signal.

3. The demultiplexer of claim 1 wherein the optical data signal comprises a polarization multiplexed optical signal.

4. The demultiplexer of claim 3 further comprising a polarization beamsplitter having an input that receives the polarization multiplexed optical signal, the polarization beam splitter splitting the polarization multiplexed optical signal into at least two optical signals having different polarization states.

5. The demultiplexer of claim 1 wherein the optical data signal comprises a bit interleaved optical time-division multiplexed polarization multiplexed optical signal.

6. The demultiplexer of claim 1 wherein the optical data signal comprises a packet interleaved optical time-division multiplexed optical signal.

7. The demultiplexer of claim 1 wherein the control input of the respective one of the plurality of phase shifters is electrically coupled to the output of a respective one of the plurality of sampling circuits, the respective one of the plurality of phase shifters generating a phase-shifted electrical clock signal in response to the electrical signal representing one of the plurality of data channels of the optical data signal.

8. The demultiplexer of claim 1 wherein the electrical clock recovery circuit comprises:
a) a photodetector that receives the optical data signal and generates an electrical data signal that is related to the optical data signal; and
b) a phase-locked loop that synchronizes a frequency and a phase of a local oscillator onto a frequency and a phase of the electrical data signal generated by the photodetector.

9. The demultiplexer of claim 8 wherein the phase-locked loop comprises a narrow-band amplifier that amplifies the electrical data signal generated by the photodetector.

10. The demultiplexer of claim 1 further comprising a processor that has an output that is electrically coupled to the control input of one of the plurality of phase shifters.

11. The demultiplexer of claim 1 wherein at least one of the plurality of sampling circuits comprises a photodetector that receives the plurality of substantially identical optical data signals and generates an electrical data signal that is related to the optical data signal having the plurality of data channels.

12. The demultiplexer of claim 1 wherein at least one of the plurality of sampling circuits comprises an electro-absorption modulator.

13. The demultiplexer of claim 1 further comprising at least one demultiplexer circuit having an input that is electrically coupled to the output of at least one of the plurality of sampling circuits.

14. A method of demultiplexing, the method comprising:
a) generating a plurality of substantially identical optical data signals from an optical data signal having a plurality of data channels;
b) generating an electrical clock signal from the optical data signal having the plurality of data channels, the electrical clock signal being substantially synchronized to the optical data signal and having a frequency that is an integer multiple of a bit rate of one of the plurality of data channels of the optical data signal;
c) generating a plurality of phase-shifted electrical clock signals in response to at least one control signal, a respective one of the plurality of phase-shifted electrical clock signals being synchronized to a respective one of the plurality of data channels; and
d) sampling a portion of each of the plurality of substantially identical optical data signals thereby generating a plurality of sampled optical data signals, a respective one of the plurality of sampled optical data signals being synchronized to a respective one of the plurality of data channels.

15. The method of claim 14 wherein a phase shift of one of the plurality of phase shifted electrical clock signals is substantially zero.

16. The method of claim 14 wherein the optical data signal comprises a bit interleaved optical time-division multiplexed optical signal.

17. The method of claim 14 wherein the optical data signal comprises a polarization multiplexed optical signal.

18. The method of claim 14 wherein the optical data signal comprises a packet interleaved optical time-division multiplexed optical signal.

19. The method of claim 14 wherein the electrical clock signal comprises a periodic waveform having a frequency that is harmonically related to the bit rate of one of the plurality of data channels.

20. The method of claim 14 wherein the at least one control signal is related to at least one of the plurality of data channels.

21. The method of claim 14 wherein the at least one control signal is generated from one of the plurality of sampled optical data signals.

22. The method of claim 14 wherein the sampling the portion of each of the plurality of substantially identical optical data signals reduces intersymbol interference in at least one of the a plurality of sampled optical data signals.

23. The method of claim 14 further comprising demultiplexing each of the plurality of sampled optical data signals to generate a plurality of demultiplexed optical data signals.

24. A demultiplexer for polarization multiplexed optical signals comprising:
a) a polarization beamsplitter including an input that receives a polarization multiplexed optical signal having a plurality of data channels, the polarization beamsplitter generating at least two optical data signals having different polarization states at a plurality of outputs;
b) an electrical clock recovery circuit including an input that receives the polarization multiplexed optical signal, the electrical clock recovery circuit generating an electrical clock signal at an output, the electrical clock signal being substantially synchronized to the polarization multiplexed optical signal and having a frequency that is an integer multiple of a bit rate of one of the plurality of data channels;
c) a plurality of phase shifters, each of the plurality of phase shifters including a clock input that receives the electrical clock signal and including a control input, a respective one of the plurality of phase shifters generating a phase-shifted electrical clock signal in response to a signal applied to the control input of the respective one of the plurality of phase shifters; and
d) a plurality of sampling circuits, each of the plurality of sampling circuits including a data input that receives one of the at least two optical data signals, and including a clock input that receives one of the phase-shifted electrical clock signals, each of the plurality of sampling circuits generating an electrical signal representing one of the plurality of data channels of the polarization multiplexed optical signal at an output.

25. The demultiplexer of claim 24 wherein the polarization multiplexed optical signal comprises a bit interleaved optical time-division multiplexed polarization multiplexed optical signal.

26. The demultiplexer of claim 24 wherein the polarization multiplexed optical signal comprises a packet interleaved optical time-division multiplexed polarization multiplexed optical signal.

27. The demultiplexer of claim 24 wherein the control input of the respective one of the plurality of phase shifters is electrically coupled to the output of a respective one of the plurality of sampling circuits, the respective one of the plurality of phase shifters generating a phase-shifted electrical clock signal in response to the electrical signal representing one of the plurality of data channels of the polarization multiplexed optical signal.

28. The demultiplexer of claim 24 wherein at least one of the plurality of sampling circuits comprises a photodetector that receives the one of the at least two optical data signals and generates an electrical data signal that is related to the polarization multiplexed optical signal having the plurality of data channels.

29. The demultiplexer of claim 24 further comprising at least one demultiplexer circuit having an input that is electrically coupled to the output of at least one of the plurality of sampling circuits.

30. The demultiplexer of claim 24 wherein the input of the electrical clock recovery circuit receives one of the at least two optical data signals to generate the electrical clock signal at the output.

31. A method of demultiplexing polarization multiplexed optical signals, the method comprising:
a) generating at least two optical data signals having different polarization states from a polarization multiplexed optical signal having a plurality of data channels;
b) generating an electrical clock signal from the polarization multiplexed optical signal, the electrical clock signal being substantially synchronized to the polarization multiplexed optical signal and having a frequency that is an integer multiple of a bit rate of one of the plurality of data channels;
c) generating a plurality of phase-shifted electrical clock signals in response to at least one control signal, a respective one of the plurality of phase-shifted electrical clock signals being synchronized to a respective one of the plurality of data channels; and
d) sampling a portion of each of the at least two optical data signals thereby generating at least two sampled optical data signals, a respective one of the at least two sampled optical data signals being synchronized to a respective one of the plurality of data channels.

32. The method of claim 31 wherein a phase shift of one of the plurality of phase shifted electrical clock signals is substantially zero.

33. The method of claim 31 wherein the polarization multiplexed optical signal comprises a bit interleaved optical time-division multiplexed polarization multiplexed optical signal.

34. The method of claim 31 wherein the polarization multiplexed optical signal comprises a packet interleaved optical time-division multiplexed polarization multiplexed optical signal.

35. The method of claim 31 wherein the at least one control signal is generated by the sampling one of the at least two optical data signals.

36. The method of claim 31 wherein the sampling the portion of each of the at least two optical data signals reduces intersymbol interference in at least one of the at least two sampled optical data signals.

37. The method of claim 31 further comprising demultiplexing each of the at least two sampled optical data signals to generate a plurality of demultiplexed optical data signals.

38. The method of claim 31 wherein the electrical clock signal is generated by one of the at least two optical data signals.
